(19) United States
(12) Patent Application Publication
(10) Pub. No.: US 2012/0011983 A1
(43) Pub. Date: Jan. 19, 2012

(54) Air flow restrictor for stringed instruments having a sound box

(76) Inventor: Angelo Koumarianos, Toms River, NJ (US)

(21) Appl. No.: 13/134,666

(22) Filed: Jun. 15, 2011

Related U.S. Application Data
(60) Provisional application No. 61/399,530, filed on Jul. 14, 2010.

(51) Int. Cl. G10D 3/00

(52) U.S. Cl. 84/291

(57) ABSTRACT

An air flow restrictor which is adjustable and removable and is installed on the sound hole of a stringed instrument having a sound box to interrupt and/or restrict the air flow emanating from the sound box through the sound hole so as to affect tonal quality.

### RELATED APPLICATIONS

Applicant claims the benefit of provisional application Ser. No. 61/399,530, filed Jul. 14, 2010.

### BACKGROUND OF THE INVENTION

1. Field of the Invention

The present invention relates to an adjustable air flow restrictor for stringed instruments having a sound box, and one or more sound holes.

2. Description of the Prior Art

Stringed instruments having a sound box, and one or more sound holes for the creation of music, include the violin, the viola, the viola cello, the double bass cello, and the guitar. Through the use of fingers, and/or a bow, the musician creates sound and music by manipulating the strings drawn taughtly over the exterior of the instrument, causing air vibration within the sound box, which emanate through the sound holes.

With respect to the violin, viola, viola cello, and double bass cello, the sound holes are normally in the form of a S-shaped curve formed in the sound board, the sound board being that surface of the instrument proximate the taut strings. The S-shaped curve sound holes are positioned symmetrically on both sides of the strings, proximate the bridge of the instrument.

The sound holes are normally unrestricted during play allowing for the instrument to provide the tonal quality particular to the instrument. However, there may be situations when it is desirable to interrupt or restrict the air flow through the sound holes in order to obtain a different tonal quality.

### OBJECTS OF THE INVENTION

An object of the present invention is to provide for a novel air flow restrictor which can be easily installed and removed from the sound hole of a stringed instrument having a sound box in order to affect the tonal quality of the instrument.

A still further object of the present invention is to provide for a novel adjustable air flow restrictor for installation on the sound hole of a stringed instrument having a sound box.

### SUMMARY OF THE INVENTION

An air flow restrictor which is adjustable and removable and is installed on the sound hole of a stringed instrument having a sound box to interrupt and/or restrict the air flow emanating from the sound box through the sound hole so as to affect tonal quality.

### BRIEF DESCRIPTION OF THE DRAWINGS

These and other objects of the present invention will become apparent, particularly when taken in light of the following illustrations wherein:

FIG. 1 is a front view of a violin representing the type of instrument to which the invention pertains;

FIG. 2 is a cross-sectional view of the violin of FIG. 1 on Plane 2-2;

FIG. 3 is an exploded perspective view of a first embodiment of an air restrictor of the present invention;

FIG. 4 is a perspective view of the first embodiment of the air restrictor of the present invention;

FIG. 5 is an exploded view of a second embodiment of an air restrictor of the present invention;

FIG. 6 is a cross-sectional view of the first embodiment of an air restrictor as removably positioned on a sound hole of a musical instrument such as illustrated in FIG. 1; and

FIG. 7 is a top planar view of the second embodiment of the present invention removably secured to a sound hole of a musical instrument such as illustrated in FIG. 1.

### DETAILED DESCRIPTION OF THE INVENTION

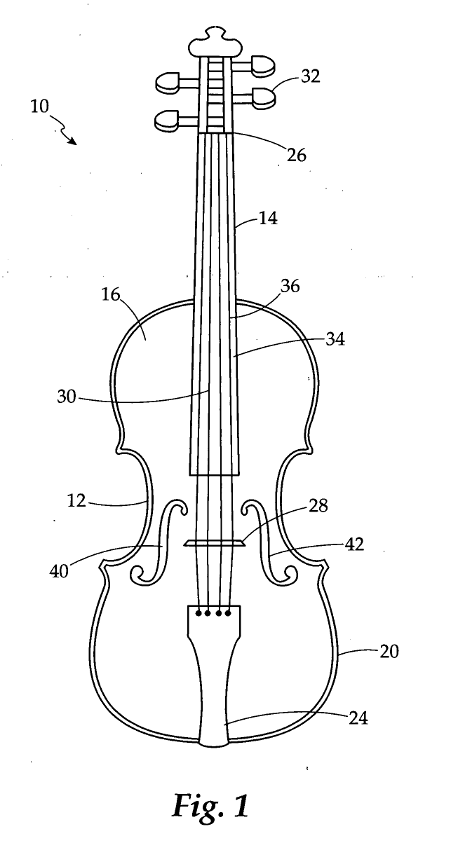

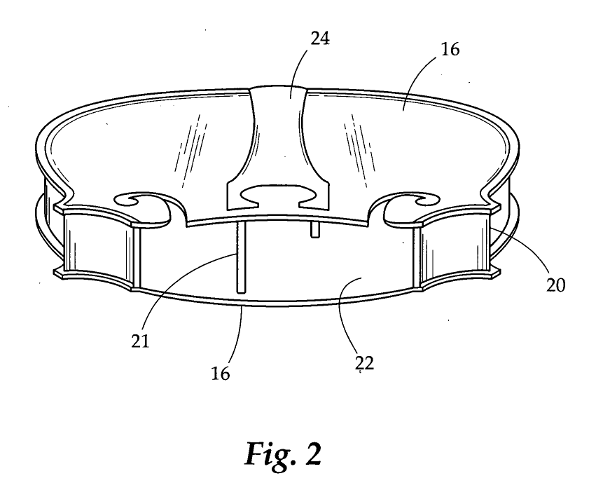

FIG. 1 is a front view of a violin 10 which is a stringed instrument incorporating a sound box, and FIG. 2 is a cross-sectional view of the violin 10 of FIG. 1. The violin 10 comprises a body 12 and a neck 14. The body 12 comprises a front face or sound board 16, and a back 18, with an arcuate circumferential periphery 20. The sound board 16, back 18, and arcuate circumferential periphery 20 define an enclosed sound box 22 having a sound post 21. Mounted to body 10 is a tail piece 24 and neck 14. Neck 14 terminates with a peg box 26. Also mounted on sound board 16 is a bridge 28. A plurality of strings 30, are anchored in tail piece 24 and tautly stretched across bridge 28 and down neck 14 terminating at peg box 26 which includes a plurality of pegs 32 for adjusting the tautness of strings 30. The top face 34 of neck 14 serves as the fingerboard 36 for applying pressure to the strings with the fingers of the hand, while a bow is drawn across the strings at a position proximate bridge 28.

There is formed in sound board 16 two sound holes 40 and 42 proximate to and on opposing sides of bridge 28. These sound holes 40 and 42 are in the form of mirror image, S-shaped curves. The action of the fingers on the fingerboard 36 and the bow drawn across the strings 30 causes vibrations within the sound box 22 which emanate as the tonal quality of the violin through the sound holes 40 and 42.

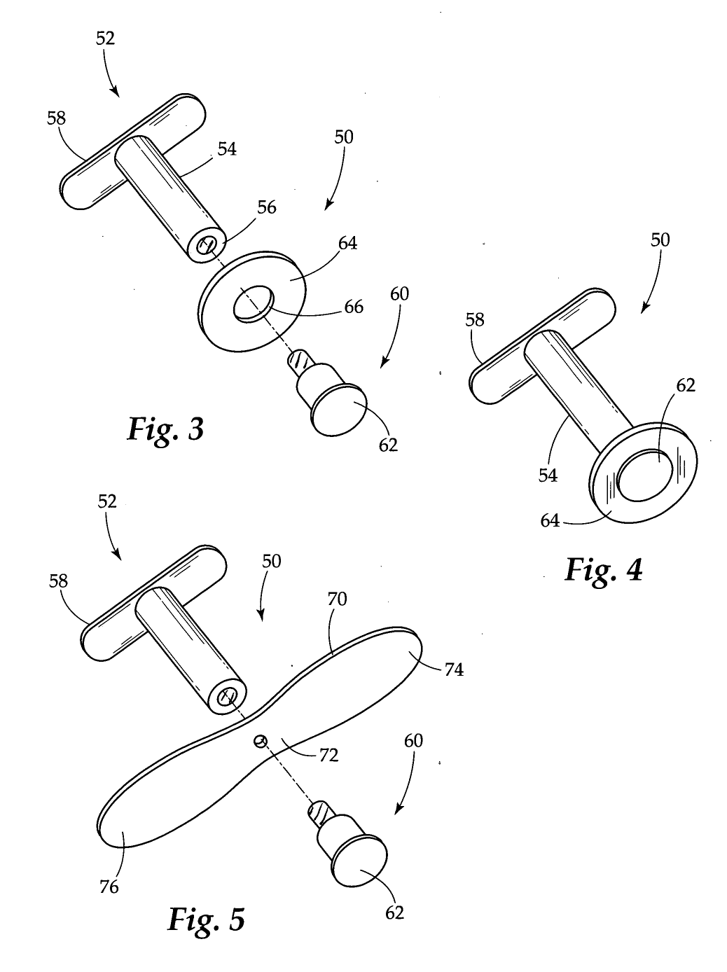

FIG. 3 is an exploded view of Applicant's air restrictor, and FIG. 4 is a perspective view of Applicant's air restrictor. Air restrictor 50 comprises a T-shaped receiver 52 having a cylindrical leg 54 having an internal threaded bore 56 formed therein. Cylindrical leg 54 terminates in a planar cross member 58. Threaded interior bore 56 is dimensioned to receive an exteriorly threaded fastener member 60 having a finger tip engagable fastener 62. The restrictor assembly also includes a restrictor plate 64 having an aperture 66 therethrough. Aperture 66 in restrictor plate 64 is alignable with the bore 56 of T-shaped receiver 52 and is secured between T-shaped receiver 52 and exteriorly threaded fastener 60 when exteriorly threaded fastener 60 is secured in bore 56.

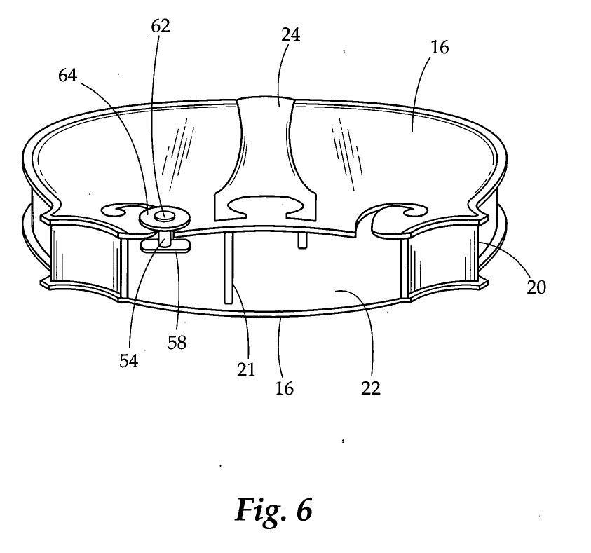

FIG. 6, a cross sectional view, is illustrative of the air restriction assembly secured to a sound hole 40 of a violin. The air restrictor assembly is dimensioned such that the distance A between the planar cross member 58 and the restrictor plate 64 when secured to the assembly is equal to the thickness of the sound board 16 of the violin or similar stringed instrument. With the air restrictor assembly assembled, the exteriorly threaded fastener 60 is loosened slightly and allows the planar cross member 58 to be inserted through a sound hole 40 or 42 and then turned 90 degrees such that the planar cross member 58 now traverses the sound hole 40 or 42. The exteriorly threaded fastener 60 is then tightened, which compresses the restrictor plate 64 against the outer surface of sound board 16, thus partially restricting air flow through the sound hole 40 or 42. An identical air restrictor assembly could also be applied to the opposing sound hole. The musician, by loosening the exteriorly threaded fastener could slide the air restrictor assembly within the sound hole to any desired position to achieve the desired tonal quality.

FIG. 5 is illustrative of the air restriction assembly secured to a sound hole 40 of a violin.

With respect to the first embodiment of the air restrictor assembly as illustrated in FIGS. 3, 4, and 6, the restrictor plate 64 is illustrated as being disc shaped. In this configuration, the user can position the restrictor plate at any desired point along a single air hole or using two restrictor plates 64, position of restrictor plate at any desired location on both sound holes.

It will be recognized by those having ordinary skill in the art that the selection of a disc shaped or circular air restrictor is one of choice, and that any suitable geometric shape may equally perform.

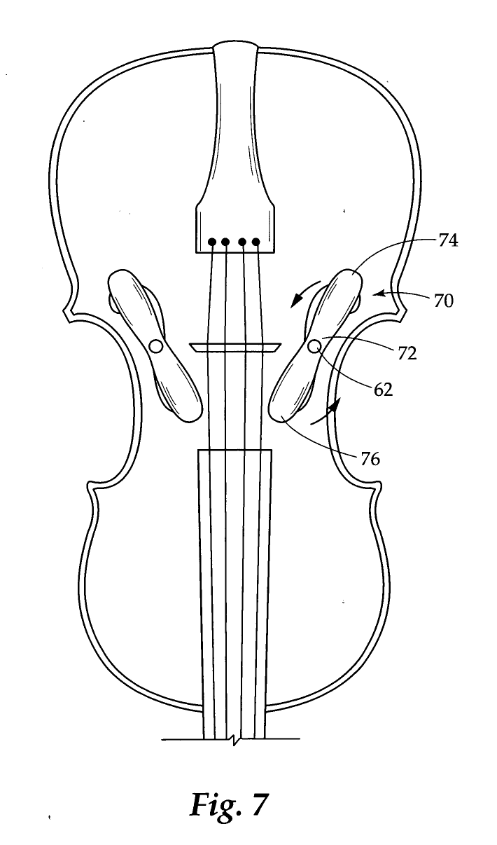

FIG. 5 is an exploded view of a second embodiment of an air restrictor of the present invention, and FIG. 7 is a top planar view of this second embodiment of the air restrictor of the present invention removably secured to a sound hole of a musical instrument such as illustrated in FIG. 1. The second embodiment utilizes a T-shaped receiver 52 identical to that illustrated in FIGS. 3 and 4 with respect to the first embodiment. It also utilizes an exteriorly threaded fastener member 60 identical to that as utilized in the first embodiment as illustrated in FIGS. 3 and 4. The difference between the first embodiment and the second embodiment lies in the shape of the restrictor plate. The second embodiment, restrictor plate 70, is propeller shaped having a central narrow body portion 72 the width of which is greater than the width of the sound hole. From the central body portion, the restrictor plate 70 extends outwardly in 180 degree relationship to form two tear drop end portions 74 and 76. The body of restrictor plate 70 is dimensioned such that it could substantially cover an entire sound hole 40 or 42. Restrictor plate 70 would be positioned in sound hole 70 in the same manner as the first embodiment, only it would be centrally positioned such that the restrictor plate 70 once installed, could be rotated to effectuate the opening or closure of sound hole at both ends of the sound hole simultaneously as opposed to having loosen and slide and retighten the restrictor plate of the first embodiment.

Therefore, while the present invention has been disclosed with respect to the preferred embodiments thereof, it will be recognized by those of ordinary skill in the art that various changes and modifications can be made without departing from the spirit and scope of the invention. It is therefore manifestly intended that the invention be limited only by the claims and the equivalence thereof.

I claim:

1. An air flow restrictor to affect the tonal quality of a stringed instrument having a sound box, and a pair of elongated S-shaped sound holes, the air flow restrictor comprising:
a T-shaped member comprising a leg member and a cross member, said cross member secured to a first end of said leg member, and dimensioned to span a width of an elongate S-shaped sound hole of a stringed instrument, a second end of said leg member having an internal threaded bore, the length of said leg member equaling the thickness of a sound board, said sound board comprising the front face of a stringed instrument having a sound box and a pair of elongated S-shaped sound holes;
a planar restrictor plate dimensioned to span the width of said elongate S-shaped sound hole of said stringed instrument, said restrictor plate juxtaposed said second end of said leg of said T-shaped member, said restrictor plate formed with an aperture for the passage of a threaded fastener member, said threaded fastener member being exteriorly threaded for receipt within said internal threaded bore of said T-shaped member.

2. The air restrictor member in accordance with claim 1 wherein said cross member of said T-shaped member has a planar upper surface.

3. The air restrictor member in accordance with claim 1 wherein said air restrictor member is selectively slidably positionable to a selected location on said elongated S-shaped air hole.

4. The air restrictor member in accordance with claim 1 wherein said restrictor member disk shaped and is formed of a flexible resilient material.

5. The air restrictor member in accordance with claim 1 wherein said air restrictor is elongate and centrally positioned on said sound hole and covers said sound hole and is pivoted on said T-shaped member to selectively restrict said sound hole.

6. A method of affecting the tonal quality of a stringed instrument having a sound box, and a pair of elongated S-shaped air holes, the method comprising:
assembling an air restrictor member comprising a T-shaped member having a leg member and a cross member secured to a first end of said leg member, said second end of said leg member having an internal threaded bore;
aligning said internal threaded bore with a planar restrictor member having a centrally disposed aperture;
mating said restrictor member and said T-shaped member by means of a fastener member having an externally threaded leg to form an air restrictor member;
inserting said T-shaped member into an air hole of a stringed instrument and rotating said T-shaped member until said cross member spans the width of said elongated S-shaped air hole;
tightening said fastener member and said T-shaped member such that said cross member and said restrictor member sandwich an edge portion of a sound board surrounding said elongated S-shaped air hole between them;
selectively slidably adjusting the position of said air restrictor on said air hole to achieve a desired tonal quality.
